(19) United States
(12) Patent Application Publication
(10) Pub. No.: US 2017/0171568 A1
(43) Pub. Date: Jun. 15, 2017

(54) METHOD AND DEVICE FOR PROCESSING LIVE VIDEO

(71) Applicants: Le Holdings (Beijing) Co., Ltd., Beijing (CN); LeCloud Computing Co., Ltd., Beijing (CN)

(72) Inventors: Fengyu LIU, Beijing (CN); Lizhi Wei, Beijing (CN); Xiao Xu, Beijing (CN); Zhonghua Lin, Beijing (CN)

(21) Appl. No.: 15/246,511

(22) Filed: Aug. 24, 2016

Related U.S. Application Data
(63) Continuation of application No. PCT/CN2016/088876, filed on Jul. 6, 2016.

(30) Foreign Application Priority Data
Dec. 14, 2015 (CN) 201510926222.0

(51) Int. Cl. H04N 21/2187; H04N 21/61; H04N 21/262; H04L 29/12; H04N 21/2743; H04N 21/2343; H04N 21/234

(52) U.S. Cl. CPC H04N 21/2187; H04N 21/2343; H04N 21/6125; H04N 21/23406; H04N 21/23418; H04L 61/1511; H04N 21/2743; H04N 21/262

(57) ABSTRACT

Disclosed are a method and a device for processing live video. The method for processing live video includes: receiving, by a CDN server, a request for playing video sent from a player, wherein a video format supported by the player and identification information of the requested video are carried in the request; obtaining an access path of the requested video according to the identification information of the requested video; obtaining the requested video from a resource server corresponding to the access path; converting a format of the requested video to the video format supported by the player; and sending the player the requested video which can be played on the player.

### CROSS REFERENCE TO RELATED APPLICATIONS

This application is a continuation of International Application No. PCT/CN2016/088876, filed on Jul. 6, 2016, which is based upon and claims priority to Chinese Patent Application No. 201510926222.0, filed on Dec. 14, 2015, the entire contents of which are incorporated herein by reference.

### TECHNICAL FIELD

The present disclosure relates to computer technologies, and more particularly, to a method and a device for processing live video.

### BACKGROUND

Online live broadcast, which is based on the Internet platform, offers people with more operational initiatives as compared with conventional live broadcast. In other words, people can have better options and can choose more freely. For example, current popular live broadcast of sport events like ball games, wedding, opening of new business and the like, bring great convenience to users. For example, signals about these broadcasts are posted on the Internet, users can conveniently select live broadcast paths as desired by them, and then they can view the online live video at any place where networks are available. Online live broadcasts are generally implemented as follows. A user produces streaming media data for live video broadcasting, and then uploads the streaming media data to a live platform via networks. When other users request to view the live video, a resource server in the live platform can send the streaming media data of the live video to the users who want to view the video.

At present, in order to satisfy requirements of live video formats for different viewers, a resource server needs to store live video of different formats. However, in order to store live video of different formats in the resource server, the resource server needs to receive the requests for uploading live video of different formats sent from users who request live broadcasts, and then obtains the live video of different format from an origin server corresponding to the user who produces the live video. By such process manner, data is repeatedly obtained, thereby resulting in waste of system resources.

### SUMMARY

The present disclosure provides a method and a device for processing live video so as to resolve the problem of waste in system resources resulted from storage of live video of different formats in a resource server by converting live video format by a CDN server.

In order to realize the above objective, the present disclosure generally provides the following technical solutions.

In a first aspect, embodiments of the present disclosure provide a method for processing live video, implemented by a CDN server, including:

receiving a request for playing video sent from a player, wherein a video format supported by the player and identification information of the requested video are carried in the request;

obtaining an access path of the requested video according to the identification information of the requested video;

obtaining the requested video from a resource server corresponding to the access path;

converting a format of the requested video to the video format supported by the player; and

sending the player the requested video which can be played on the player.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for processing live video mentioned by embodiments of the present disclosure.

In a third aspect, embodiments of the present disclosure provide a non-transitory computer-readable storage medium storing executable instructions that, when executed by an electronic device, cause the electronic device to perform any methods for processing live video mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for processing live video in accordance with some embodiments.

FIG. 2 is a flow chart of another method for processing live video in accordance with some embodiments.

FIG. 3 is a block diagram showing a structure of a CDN server in accordance with some embodiments.

FIG. 4 is a block diagram showing a structure of another CDN server in accordance with some embodiments.

FIG. 5 is a block diagram showing a structure of a server in accordance with some embodiments.

FIG. 6 is a block diagram showing a structure of an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

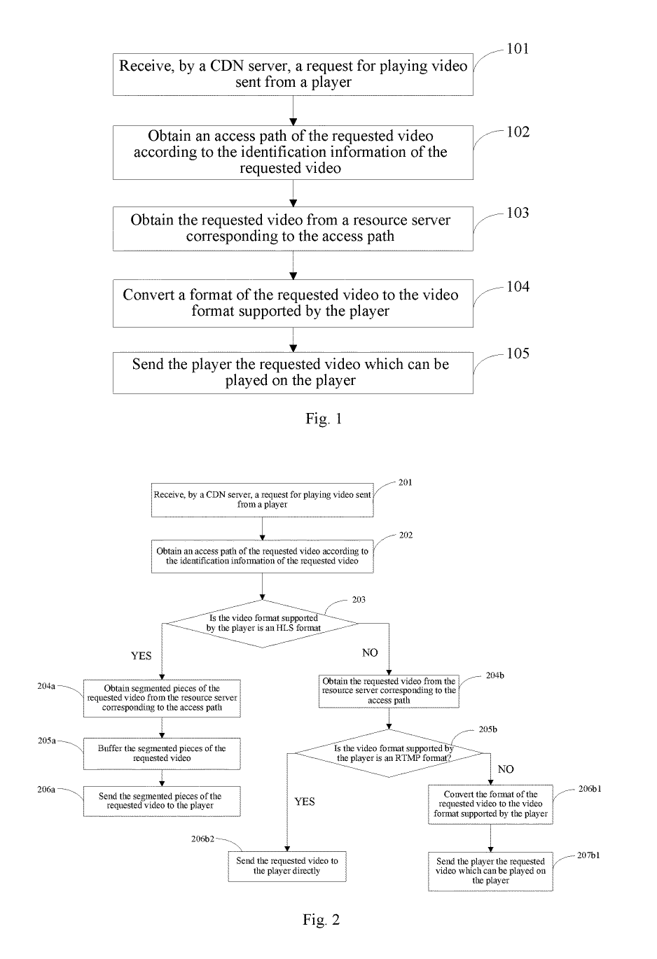

An embodiment of the present disclosure provides a method for processing live video. As shown in FIG. 1, the method is applied in a CDN server and can specifically include the following steps.

In 101, the CDN server receives a request for playing video sent from a player.

A video format supported by the player and identification information of the requested video can be carried in the request. Content Delivery Networks (CDN) can avoid bottlenecks and parts across the Internet which may influence speed and stability of data transmission as far as possible and thus can deliver contents more quickly and stably. In the embodiment of the present disclosure, different clients may adopt different players which may require different video formats. Thus, when a player sends a request for playing video, the player needs to designate the play format supported by the player in the request so that the live video returned in response to the request can be played on the local player. In embodiments of the present disclosure, for example, the player can support video formats such as FLU (Flash Video), HLS (HTTP Live Streaming, a dynamic adaptive streaming technology implemented by Apple Inc.), RTMP (Real Time Messaging Protocol), and the like, and embodiments of the present disclosure are not limited to the above listed formats.

It should be noted that the CDN server receives the request for playing video from a DNS (Domain Name System) server corresponding to the player. The DNS server is adapt to receive the request sent from the player and configure the CDN server corresponding to the client. After receiving the request for playing video sent from the player, the DNS parses the IP address corresponding to the player, and assign, according the parse result and the operator corresponding to the player, a CDN server which is closest to the player, belongs to the same operator as the player and has the lightest load, and then the CDN server receives the request for playing video from the player. In embodiments of the present disclosure, two servers which are belong to the same operator and are adjacent to each other geographically can perform data transmission with high efficiency, and thus transmitting live video data using such CDN server can improve transmission efficiency of live video.

In 102, the CDN server obtains an access path of the requested video according to the identification information of the requested video.

The identification information of the requested video can identify the video requested by the player. In the embodiment of the present disclosure, after receiving the request for playing video sent from the player, the CDN server obtains the access path of the requested video according to the identification information of the requested video in the request. Specifically, the CDN server can send the identification information of the requested video to a scheduling server. After receiving the identification information of the requested video sent from the CDN server, the scheduling server obtains the access path corresponding to the identification information of the requested video, and then sends the access path corresponding to the identification information of the requested video to the CDN server.

In 103, the CDN server obtains the requested video from a resource server corresponding to the access path.

In the embodiment of the present disclosure, after obtaining the access path of the requested video, the CDN server can find a corresponding resource server using the access path, and then obtain the requested video from the resource server.

In 104, the CDN server converts a format of the requested video to the video format supported by the player.

For example, if the format of the requested video obtained by the CDN server is RTMP, and the video format supported by the player is FLV which is different from the format of the requested video, it is needed to convert the format of the requested video from the RTMP format to the FLV format, so that the requested video can be normally played on the player.

In 105, the CDN server sends the requested video which can be played on the player to the player.

In the embodiment of the present disclosure, according to a received request for playing video, the video resource corresponding to the request is firstly obtained from a resource server, and then the format of the video resource is converted to a video format supported by the player, and finally the video resource which can be played on the player or is suitable for being played on the player is sent to the player. In this way, requirements of live video formats can be met for different players. In the resource server of the present disclosure, the requirements of video formats can be met for different players by storing each live video in only one format. Consequently, using the technical solutions in the present disclosure, the number of times the resource server obtains video resources from origin servers of users who produce live video can be reduced, thereby saving system resources.

Correspondingly, an embodiment of the present disclosure provides a method for processing live video. As shown in FIG. 2, the method is applied in a scheduling server and can include the following steps.

In 201, a CDN server receives a request for playing video sent from a player.

A video format supported by the player and identification information of the requested video can be carried in the request.

In 202, the CDN server obtains an access path of the requested video according to the identification information of the requested video.

In embodiments of the present disclosure, the obtaining of the access path of the requested video according to the identification information of the requested video can include: sending the identification information of the requested video to the scheduling server so that the scheduling server obtains the access path corresponding to the identification information of the requested video; and receiving the access path sent from the scheduling server.

In 203, the CDN server determines whether a video format supported by the player is an HLS format.

HLS, a dynamic adaptive streaming technology implemented by Apple Inc, is mainly applied in audio and video services in PCs and Apple terminals. According to this technology, an m3u(8) index file, TS media segment files and key encrypted string files are created.

In 204a, if the video format supported by the player is the HLS format, the CDN server obtains segmented pieces of the requested video from the resource server corresponding to the access path.

In embodiments of the present disclosure, because the playing of the live video based on the HLS protocol is implemented by TS media segment files, the segmented pieces of the requested video need to be obtained from the resource server corresponding to the access path if the format supported by the player is the HLS format. It should be noted that the format of the requested video in the resource server can be an RTMP format by default, for example, and thus if the video format supported by the player is the HLS, the requested video of the RTMP format needs to be segmented in the resource server, for example, each TS media segment has a duration of six seconds, and the resulted files are the segmented pieces of the requested video.

In 205a, the CDN server buffers the segmented pieces of the requested video.

In embodiments of the present disclosure, after obtaining the segmented pieces of the requested video from the resource server corresponding to the access path, the CDN server can buffer the segmented pieces of the requested video. In this way, when a new user wants to obtain the live video, the video resource can be obtained directly from the CDN server without another conversion of video format, thereby improving efficiency of obtaining of the live video by the player.

In 206a, the CDN server sends the segmented pieces of the requested video to the player.

In 204b, if the video format supported by the player is not the HLS format, the CDN server obtains the requested video from the resource server corresponding to the access path.

The steps 204a and 204b are parallel steps. That is, if the video format supported by the player is not the HLS format, the requested video is obtained from the resource server corresponding to the access path.

In 205b, the CDN server determines whether the video format supported by the player is an RTMP format.

In 206b1, if the video format supported by the player is not the RTMP format, the CDN server converts the format of the requested video to the video format supported by the player.

In embodiments of the present disclosure, if the video format supported by the player is an FLV format, for example, the conversion of the format of the requested video to the video format supported by the player can include: converting the format of the requested video to the FLV format; and buffering the requested video of the FLV format.

In 207b1, the CDN server sends the requested video which can be played on the player to the player.

In 206b2, if the video format supported by the player is the RTMP format, the CDN server directly sends the requested video to the player.

The steps 206b2 and 206b1 are parallel steps. That is, if the video format supported by the player is the RTMP format, it is indicated that the video format supported by the player is consistent with the default format of the requested video obtained from the resource server, and thus the requested video can be directly sent to the player without conversion of video format, and the player can directly play the video.

In embodiments of the present disclosure, after receiving a request for playing video sent from a player, a CDN server obtains an access path of the requested video according to identification information of the requested video in the request, and then determines whether a video format supported by the player is an HLS format. If the video format supported by the player is the HLS format, the CDN server obtains segmented pieces of the requested video from a resource server corresponding to the access path, and then buffers the segmented pieces of the requested video and sends them to the player. On the contrary, if the video format supported by the player is not the HLS format, the CDN server obtains the requested video from the resource server corresponding to the access path, and then determines whether the video format supported by the player is an RTMP format. If the video format supported by the player is the RTMP format, the CDN server directly sends the requested video to the player. If the video format supported by the player is not the RTMP format, the CDN server converts the format of the requested video to the video format supported by the player, and then sends the player the requested video which can be displayed on the player or is suitable for being played on the player. In the resource server of the present disclosure, the requirements of live video formats can be met for different players by storing each live video in only one format. Consequently, using the technical solutions in the present disclosure, the number of times the resource server obtains video resources from origin servers of users who produce live video can be reduced, thereby saving system resources.

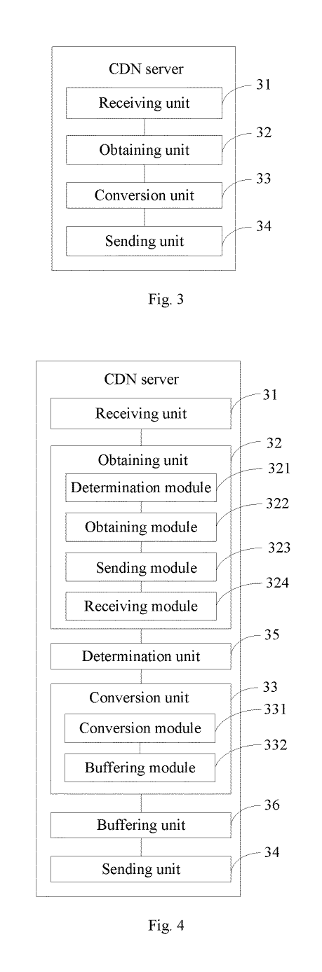

Further, an embodiment of the present disclosure provides a CDN server to implement the above method. As shown in FIG. 3, the CDN server includes a receiving unit 31, an obtaining unit 32, a conversion unit 33 and a sending unit 34.

The receiving unit 31 is configured to receive a request for playing video sent from a player. A video format supported by the player and identification information of the requested video can be carried in the request. For example, the player can support video formats such as FLU (Flash Video), HLS (HTTP Live Streaming, a dynamic adaptive streaming technology implemented by Apple Inc.), RTMP (Real Time Messaging Protocol), and the like, and embodiments of the present disclosure are not limited to the above listed formats.

The obtaining unit 32 is configured to obtain an access path of the requested video according to the identification information of the requested video received by the receiving unit 31. The obtaining of the access path of the requested video according to the identification information of the requested video can include: sending the identification information of the requested video to a scheduling server so that the scheduling server obtains the access path corresponding to the identification information of the requested video; and receiving the access path sent from the scheduling server.

The obtaining unit 32 is further configured to obtain the requested video from a resource server corresponding to the access path. After obtaining the access path of the requested video, the CDN server can find a corresponding resource server using the access path, and then obtain the requested video from the resource server.

The conversion unit 33 is configured to convert a format of the requested video received by the obtaining unit 32 to the video format supported by the player.

The sending unit 34 is configured to send the player the requested video which is converted by the conversion unit 33 and can be played on the player, so that the player can play the requested video.

Further, as shown in FIG. 4, the CDN server can further include a determination unit 35.

The determination unit 35 is configured to determine whether the video formatted supported by the player is a RTMP format.

The conversion unit 33 is configured to convert the format of the requested video to the video format supported by the player if the video format supported by the player is not the RTMP format.

The sending unit 34 is configured to directly send the requested video to the player if the video format supported by the player is the RTMP format.

Specifically, the conversion unit 33 can include a conversion module 331 and a buffering module 332.

The conversion module 331 is configured to convert the format of the requested video to the FLV format when the video format supported by the player is a FLV format.

The buffering module 332 is configured to buffer the requested video of the FLV format.

Specifically, the obtaining unit 32 can include a determination module 321 and an obtaining module 322.

The determination module 321 is configured to determine whether the video format supported by the player is an HLS format. HLS, a dynamic adaptive streaming technology implemented by Apple Inc, is mainly applied in audio and video services in PCs and Apple terminals. According to this technology, an m3u(8) index file, TS media segment files and key encrypted string files are created.

The obtaining module 322 is configured to obtain segmented pieces of the requested video from the resource server corresponding to the access path if the determination module 321 determines that the video format supported by the player is the HLS format. It should be noted that the format of the requested video in the resource server can be an RTMP format by default, for example, and thus if the video format supported by the player is the HLS, the requested video of the RTMP format needs to be segmented in the resource server, for example, each TS media segment has a duration of six seconds, and the resulted files are the segmented pieces of the requested video.

Further, the CDN server can further include a buffering unit 36.

The buffering unit 36 is configured to buffer the segmented pieces of the requested video obtained by the obtaining unit 32. In embodiments of the present disclosure, by buffering the segmented pieces of the requested in the CDN server, when a new user wants to obtain the live video, the video resource can be obtained directly from the CDN server without another conversion of video format, thereby improving efficiency of obtaining of the live video by the player.

The sending unit 34 is configured to send the segmented pieces of the requested video obtained by the obtaining unit 32 to the player.

Specifically, the receiving unit 31 is configured to receive the request for playing video sent from a Domain Name System (DNS) server corresponding to the player. The DNS server is adapt to receive the request for playing video sent from the player and configure the CDN server corresponding to the player.

Specifically, the obtaining unit 32 further includes a sending module 323 and a receiving module 324.

The sending module 323 is configured to send the identification information of the requested video received by the receiving unit 31 to a scheduling server so that the scheduling server obtains the access path corresponding to the identification information of the requested video.

The receiving module 324 is configured to receive the access path which is sent from the scheduling server in response to the identification information of the requested video sent by the sending module 323.

In view of the above, firstly, a CDN server receives a request for playing video sent from a player. A video format supported by the player and identification information of the requested video can be carried in the request. Then, the CDN server obtains an access path of the requested video according to the identification information of the requested video, obtains the requested video from a resource server corresponding to the access path, and converts a format of the requested video to the video format supported by the player. Finally, the CDN server sends the player the requested video which can be played on the player. As compared with conventional technologies in which live video of different formats are stored in a resource server to meet requirements of video formats for different players, the technical solution in the present disclosure firstly obtains, according to a received request for playing video, the video resource corresponding to the request from a resource server, and then converts the format of the video resource to a video format supported by the player, and finally sends the player the video resource which can be played on the player. In this way, requirements of video formats can be met for different players. In the resource server of the present disclosure, the requirements of live video formats can be met for different players by storing each live video in only one format. Consequently, using the technical solutions in the present disclosure, the number of times the resource server obtains video resources from origin servers of users who produce live video can be reduced, thereby saving system resources.

It should be noted that the functions of respective units or modules in the above CDN server according to embodiments of the present disclosure can be realized by hardware processors.

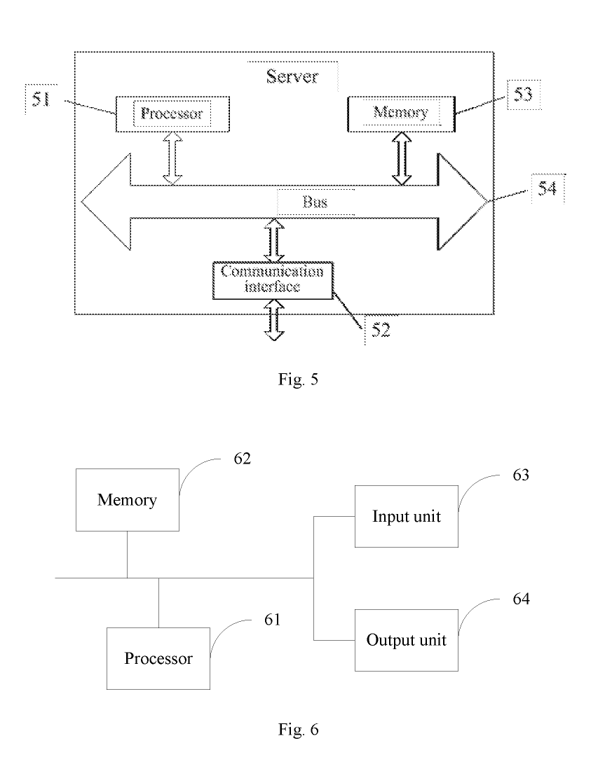

As an example, FIG. 5 is a block diagram showing a physical structure of a server in accordance with an embodiment of the present disclosure. The server can include a processor 51, a communication interface 52, a memory 3 and a bus 54. The processor 51, the communication interface 52 and the memory 53 communicate with each other via the bus 54. The communication interface 52 may be used for information transmission between the server and a client. The processor 51 calls logic instructions in the memory 53 to perform the following method: receiving, by the CDN server, a request for playing video sent from a player, wherein a video format supported by the player and identification information of the requested video are carried in the request; obtaining an access path of the requested video according to the identification information of the requested video; obtaining the requested video from a resource server corresponding to the access path; converting a format of the requested video to the video format supported by the player; and sending the player the requested video which can be played on the player.

In addition, the logic instructions in the memory 53 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for processing live video mentioned by embodiments of the present disclosure.

FIG. 6 is a block diagram of an electronic device which is configured to perform the methods for processing live video according to an embodiment of the present disclosure. As shown in FIG. 6, the device includes: one or more processors 61 and memory 62. A processor 61 is showed in FIG. 6 for an example.

Device which is configured to perform the methods for processing live video can also include: input unit 63 and output unit 64.

Processor 61, memory 62, input unit 63 and output unit 64 can be connected by BUS or other methods, and BUS connecting is showed in FIG. 6 for an example.

Memory 62 can be used for storing non-transitory software program, non-transitory computer executable program and modules as a non-transitory computer-readable storage medium, such as corresponding program instructions/modules for the methods for processing live video mentioned by embodiments of the present disclosure (such as shown in FIG. 3, receiving unit 31, obtaining unit 32, conversion unit 33, sending unit 34). Processor 61 performs kinds of functions and processing live video of the electronic device by executing non-transitory software program, instructions and modules which are stored in memory 62, thereby realizes the methods for processing live video mentioned by embodiments of the present disclosure.

Memory 62 can include program storage area and data storage area, thereby the operating system and applications required by at least one function can be stored in program storage area and data created by using the device for processing live video can be stored in data storage area. Furthermore, memory 62 can include high speed Random-access memory (RAM) or non-volatile memory such as magnetic disk storage device, flash memory device or other non-volatile solid state storage devices. In some embodiments, memory 62 can include long-distance setup memories relative to processor 61, which can communicate with the device for processing live video by networks. The examples of said networks are including but not limited to Internet, Intranet, LAN, mobile Internet and their combinations.

Input unit 63 can be used to receive inputted number, character information and key signals causing user configures and function controls of the device for processing live video. Output unit 64 can include a display screen or a display device.

The said module or modules are stored in memory 62 and perform the methods for processing live video when executed by one or more processors 61.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for processing live video, implemented by a CDN server, comprising:
receiving a request for playing video sent from a player, wherein a video format supported by the player and identification information of the requested video are carried in the request;
obtaining an access path of the requested video according to the identification information of the requested video;
obtaining the requested video from a resource server corresponding to the access path;
converting a format of the requested video to the video format supported by the player; and
sending the player the requested video which can be played on the player.

2. The method according to claim 1, wherein before the converting the format of the requested video to the video format supported by the player, the method further comprises:
determining whether the video formatted supported by the player is a RTMP format;
the converting of the format of the requested video to the video format supported by the player comprises:
if the video format supported by the player is not the RTMP format, converting the format of the requested video to the video format supported by the player; and
the sending of the requested video which can be played on the player to the player comprises:
if the video format supported by the player is the RTMP format, directly sending the requested video to the player.

3. The method according to claim 2, wherein when the video format supported by the player is a FLV format, the converting of the format of the requested video to the video format supported by the player comprises:
converting the format of the requested video to the FLV format; and
buffering the requested video of the FLV format.

4. The method according to claim 2, wherein the obtaining of the requested video from the resource server corresponding to the access path comprises:
determining whether the video format supported by the player is an HLS format; and
obtaining segmented pieces of the requested video from the resource server corresponding to the access path, if the video format supported by the player is the HLS format.

5. The method according to claim 4, wherein after the obtaining the requested video from the resource server corresponding to the access path, the method further comprises:
buffering the segmented pieces of the requested video; and
the sending of requested video which can be played on the player to the player comprises:
sending the segmented pieces of the requested video to the player.

6. The method according to claim 1, wherein the receiving of the request for playing video sent from the player by the CDN server, comprises:
receiving, by the CDN server, the request sent from a Domain Name System (DNS) server corresponding to the player, wherein the DNS server is adapt to receive the request sent from the player and configure the CDN server corresponding to the client with the player.

7. The method according to claim 1, wherein the obtaining of the access path of the requested video according to the identification information of the requested video comprises:
sending the identification information of the requested video to a scheduling server so that the scheduling server obtains the access path corresponding to the identification information of the requested video; and
receiving the access path sent from the scheduling server.

8. An electronic device, comprising:
at least one processor; and
a memory communicably connected with the at least one processor for storing instructions executable by the at least one processor, wherein execution of the instructions by the at least one processor causes the at least one processor to:
receive a request for playing video sent from a player, wherein a video format supported by the player and identification information of the requested video are carried in the request;
obtain an access path of the requested video according to the identification information of the requested video and obtain the requested video from a resource server corresponding to the access path;
convert a format of the requested video to the video format supported by the player; and
send the player the requested video which can be played on the player.

9. The electronic device according to claim 8, wherein before the converting the format of the requested video to the video format supported by the player, the instructions are executed to cause the at least one processor to:
determine whether the video formatted supported by the player is a RTMP format;
convert the format of the requested video to the video format supported by the player if the video format supported by the player is not the RTMP format; and
directly send the requested video to the player if the video format supported by the player is the RTMP format.

10. The electronic device according to claim 9, wherein the instructions are executed to cause the at least one processor to:
convert the format of the requested video to the FLV format when the video format supported by the player is a FLV format; and
buffer the requested video of the FLV format.

11. The electronic device according to claim 9, wherein the instructions are executed to cause the at least one processor to:
determine whether the video format supported by the player is an HLS format; and
obtain segmented pieces of the requested video from the resource server corresponding to the access path, if the video format supported by the player is the HLS format.

12. The electronic device according to claim 11, wherein after the obtaining the requested video from the resource server corresponding to the access path, the instructions are executed to cause the at least one processor to:
buffer the segmented pieces of the requested video; and
send the segmented pieces of the requested video to the player.

13. The electronic device according to claim 8, wherein the instructions are executed to cause the at least one processor to:
receive the request sent from a DNS server corresponding to the player, wherein the DNS server is adapt to receive the request sent from the player and configure the CDN server corresponding to the client with the player.

14. The electronic device according to claim 8, wherein the instructions are executed to cause the at least one processor to:
send the identification information of the requested video to a scheduling server so that the scheduling server obtains the access path corresponding to the identification information of the requested video; and
receive the access path sent from the scheduling server.

15. A non-transitory computer-readable storage medium storing executable instructions that, when executed by an electronic device, cause the electronic device to:
receive a request for playing video sent from a player, wherein a video format supported by the player and identification information of the requested video are carried in the request;
obtain an access path of the requested video according to the identification information of the requested video and obtain the requested video from a resource server corresponding to the access path;
convert a format of the requested video to the video format supported by the player; and
send the player the requested video which can be played on the player.

16. The non-transitory computer-readable storage medium according to claim 15, wherein before the converting the format of the requested video to the video format supported by the player, the executable instructions are executed to cause the electronic device to:
determine whether the video formatted supported by the player is a RTMP format;
convert the format of the requested video to the video format supported by the player if the video format supported by the player is not the RTMP format; and
directly send the requested video to the player if the video format supported by the player is the RTMP format.

17. The non-transitory computer-readable storage medium according to claim 16, wherein the executable instructions are executed to cause the electronic device to:
convert the format of the requested video to the FLV format when the video format supported by the player is a FLV format; and
buffer the requested video of the FLV format.

18. The non-transitory computer-readable storage medium according to claim 16, wherein the executable instructions are executed to cause the electronic device to:
determine whether the video format supported by the player is an HLS format; and
obtain segmented pieces of the requested video from the resource server corresponding to the access path, if the video format supported by the player is the HLS format.

19. The non-transitory computer-readable storage medium according to claim 15, wherein the executable instructions are executed to cause the electronic device to:
receive the request sent from a DNS server corresponding to the player, wherein the DNS server is adapt to receive the request sent from the player and configure the CDN server corresponding to the client with the player.

20. The non-transitory computer-readable storage medium according to claim 15, wherein the executable instructions are executed to cause the electronic device to:
send the identification information of the requested video to a scheduling server so that the scheduling server obtains the access path corresponding to the identification information of the requested video; and
receive the access path sent from the scheduling server.
